(19) United States
(12) Patent Application Publication
(10) Pub. No.: US 2024/0373801 A1
(43) Pub. Date: Nov. 14, 2024

(54) APPARATUS, PLANT AND METHOD FOR CULTIVATION OF BEET PLANTS

(71) Applicant: Suiteg GmbH, Köln (DE)

(72) Inventors: Wolfgang Klosterhalfen, Kerpen-Sindorf (DE); Martin Vesper, Wuppertal (DE)

(21) Appl. No.: 18/285,919

(22) PCT Filed: Apr. 7, 2022
(86) PCT No.: PCT/EP2022/059296

§ 371 Date: Oct. 6, 2023

(30) Foreign Application Priority Data
Apr. 9, 2021 (EP) 21167563.2

(51) Int. Cl. A01G 31/06; A01G 22/25

(52) U.S. Cl. CPC A01G 31/06; A01G 22/25

(57) ABSTRACT

Apparatus and method for cultivation of a beet plant, the apparatus includes a formative structure with a cavity for containing the beet plant, the formative structure is designed such that an outer shape of the beet plant is at least partially affected by walls of the cavity during growth of the beet plant.

### CROSS-REFERENCE TO RELATED APPLICATIONS

This application is a US National Stage Entry of PCT/EP2022/059296 filed on Apr. 7, 2022, which claims priority to EP 21167563.2 filed on Apr. 9, 2021.

### FIELD

The present invention relates to an apparatus for cultivation of beet plants, in particular sugar beets.

### BACKGROUND

Classically, sugar beets are grown by farmers in the way of field cultivation. For this purpose, peculiar soil and proper climate are necessary for successful cultivation. The soil must contain a large supply of nutrients, be rich in humus and be able to contain lots of moisture. In addition, the classical field cultivation of sugar beets is inextricably linked to a high area requirement, in particular as sugar beets need multiannual crop rotation.

Nowadays, cultivation conditions for sugar beets significantly deteriorate due to global warming caused by the long-term heating of Earth's climate system as well as changing average weather patterns in local and regional climates related thereto. In particular, as heat waves, prolonged droughts and severe weather conditions will become more frequent. At the same time the global demand for food is increasing continuously.

One approach to solving this problem can be found in the so-called inhouse or vertical farming technologies of growing crops in vertically stacked layers arranged inside buildings, containers or the like. It incorporates controlled-environment agriculture in order to optimize plant growth and to increase crop yield coming with a smaller unit area of land requirement.

A drawback of this approach until now is that vertical farming is associated with a huge energy consumption compared to classical field cultivation due to the fact that lighting, climate control and nutrient supply must be induced completely artificially. Consequently, vertical forming can only be a solution to the aforementioned challenges as far as energy balance and crop yield are improved.

Another aspect is that harvested beet plants have to be further processed in order to obtain the desired end product. Sugar beets, for example, are washed and mechanically sliced or cut into thin strips, also referred to as “cossettes”. Afterwards, the strips are passed through an extractor (also referred to as diffuser) in order to extract the sugar content into a water solution typically by way of countercurrent exchange. Obviously, suchlike further processing comes along with additional energy consumption.

### SUMMARY

It is an object of the present invention to provide an apparatus and a method for cultivation of beet plants addressing at least few of the above-mentioned challenges and drawbacks.

The object of the present invention is achieved by an apparatus for cultivation of beet plants, in particular sugar beets, comprising a formative structure with a cavity for containing a growing beet, wherein the formative structure is designed such that the outer shape of the beet is at least partially affected by walls of the cavity during growth.

According to the present invention, it is, thereby, advantageously possible to determine at least partially the outer shape of the grown beet by letting the beet grow up inside the cavity of the formative structure. If the shape of the growing beet is biased into a certain desired shape, so that the shape of the harvested beet follows a predefined form specification, the following processing of the beet can be performed in a more effective way increasing yield and reducing energy consumption. Although the present invention is not limited to vertical farming technologies which means that the apparatus according to the present invention can also be used for improved conventional field cultivation of beet plants, the major advantage is conferred through the apparatus in combination with vertical farming. It is thus possible to increase efficiency of further processing to such an extent that the overall energy balance of vertical farming together with further processing becomes better compared than the energy balance of conventional field cultivation, so that the above-mentioned general challenges and drawbacks of field cultivation can be solved. If, for example, harvested sugar beets have shapes meeting a predefined form specification and are thus more similar in shape and size to each other, further processing steps like transportation of beets, slicing beets into strips and diffusing strips in water can be implemented much easier and more efficient.

According to the present invention, it is preferred that the cavity is partly or completely filled with a liquid, gaseous and/or vaporous water and/or nutrition solution for soilless cultivation of the beet plant, in particular aeroponic or hydroponic cultivation. Advantageously, the fully grown beet must not be washed prior to further processing. Alternatively, the cavity is filled with soil for a cultivation in soil.

In the sense of the present invention, the wording “formative” means preferably that the beet contacts at least one wall of the formative element during growing up, so that the outer shape of the growing beet is biased by this wall of the formative element as the wall does not yield. That means the formative structure is designed preferably in such a manner that the size of the cavity is smaller, at least in one directional component, e.g. height or diameter, than a typical beet plant being cultivated outside the cavity till harvesting. Furthermore, the formative structure preferably comprises a base element which is rigid or semi-rigid, so that it can mechanically withstand a typical growth momentum of the growing beet. Preferably, the cavity is designed for containing only one single beet, so that the outer shape of each single beet can be formed individually into the desired form.

In particular, the present invention comprises an apparatus, a plant and a method for artificial cultivation of beet plants which means that at least an artificial light source is used to generate growing. Preferably, a soilless aeroponic or hydroponic artificial cultivation of the beet plants is intended. However, also a cultivation in soil is conceivable as an alternative.

According to the present invention, it is preferred that the formative structure comprises a base element providing the cavity, wherein the base element preferably comprises a cylindrical, conical, cuboid or cubic inner contour, particularly preferably the inner contour is shaped cuboid or cubic with rounded edges. Advantageously, a cavity with a cuboid or cubic inner contour results in a grown beet comprising at least partially a corresponding cuboidal- or cubic-shaped outer form, in particular with rounded edges. Beets formed like that can be transported easier and more efficiently as naturally formed beets because they cannot roll away and be stacked or packed with a much higher packing density.

Apart from that beets of cuboidal or cubic shape leads to more equal strips when being sliced or cut and in particular do not come with too short strips which are highly detrimental for certain further processes. Slicing naturally grown sugar beets into strips (cossettes) generally produces not only well-formed strips but also a significant number of short strips. Suchlike short strips adversely affect the countercurrent exchange inside the extractor (also referred to as diffuser) as they tend to clog the sieves in the extractor. If that happens, the countercurrent exchange must be stopped and the sieves have to be manually cleaned from clogging short strips. The cuboidal- or cubic shaped sugar beets resulting from growing up in the apparatus according to the present invention can be sliced or cut into strips with a decreased number of so-called short strips, so that clogging in the extractor is avoided and simultaneously the amount of beet waste during slicing is decreased substantially. The same applies for beets grown up in a cavity with a cylindrical inner contour, as long as the beets are e. g. sliced top-down or vice versa. Alternatively, the beets are sliced crosswise. It is also conceivable that the beets are shredded. Advantageously, the more the edges of the cavity are rounded, the easier is removal of the beet from the cavity for harvesting.

The inner contour preferably comprises a cross section with a diameter (if circular), a width or maximum extension (if cuboidal) respectively perpendicular to the vertical longitudinal axis having a diameter between 50 and 550 Millimeters, preferably between 100 and 450 Millimeters and particularly preferably between 150 and 400 Millimeters, most preferably between 250 and 350 Millimeters. The cavity has preferably a height along the vertical longitudinal axis between 50 and 400 Millimeters, preferably between 80 and 300 Millimeters and particularly preferably between 100 and 200 Millimeters.

According to the present invention, it is furthermore preferred that the base element comprises a beet holder, in particular a biodegradable support structure. The beet holder is located close to or at the top of the cavity and receives the beet seedling. Preferably, the beet seedling holder therefore holds the beet seedling close to the top of the cavity and to the light source, so that the beet can grow top-down inside the cavity.

According to the present invention, it is furthermore preferred that the base element comprises one or more liquid-permeable areas or wherein the base element is made of a liquid-permeable and preferably porous and/or perforated material. It is herewith advantageously possible to supply the beet growing up in the cavity with water and/or a nutrient solution through the liquid-permeable areas and/or pores of the porous and/or perforated material to stimulate growth of the beet. In particular, a soilless cultivation can be achieved, so that washing and cleaning of harvested beets from soil, dirt and stones is not necessary before further processing. Consequently, a complete step of further processing can be saved. Simultaneously, nutrient supply can be optimized and individually adapted to the growing rate of the beet. It is conceivable that the base element comprises a mesh made from synthetic material, metal, fibers or the like. Alternatively, the base element comprises a molded, deep drawn or laminated device, preferably pot shaped or tubular with a round, oval, angular or square cross section. The device can be made by fiberglass-reinforced plastic, preferably perforated in order to provide water-permeability.

Preferably, the base element is made of a multilayered material comprising an outer layer being impermeable to liquid, an intermediate liquid-bearing layer for distribution of water within the base element and an inner layer being permeable to liquid to guide the distributed water to the cavity. The inner layer is water-permeable but does not necessarily need to be provided with larger pores or perforations, so that the removal of the beet from the cavity remains as simple as possible. For this purpose, it is intended that ideally no parts of the roots shall grow into orifices of the base element. It is conceivable that the inner layer comprises a water-permeable synthetic film or foil. Alternatively, also an aluminum or steel foil or a composite foil is possible.

Preferably, the apparatus comprises a fluid inlet for water and/or a nutrient solution, wherein the fluid inlet is preferably connected to the intermediate liquid-bearing layer or with the perforated or porous areas.

According to the present invention, it is furthermore preferred that the base element comprises a separation area for separating the base element into at least two parts or an ejection device for removal of the beet out of the cavity, preferably an openable flap. Advantageously, the separation area allows for separating the two parts of the base element in order to easily remove the grown-up beet from the cavity. Alternatively, the base element comprises an openable flap, e.g. a hinged door through which the grown-up beet can be removed from the cavity. It is conceivable that the bottom of the base element is provided as openable flap, so that the grown-up beet can be ejected from the cavity automatically by gravity when opening the flap. Preferably, the apparatus comprises a cutting device for cutting off the head and the leaves from the grown-up beet before removal. It is conceivable that the cutting device comprises a cutting blade with a cutting office which corresponds with the aperture, wherein the head and leaves are cut off by relative movement of the cutting blade.

According to the present invention, it is furthermore preferred that the base element comprises an illumination aperture through which head and leaves of the beet plant can grow out of the cavity. In particular, the diameter of the aperture is significantly smaller than the diameter of a typical beet and/or overlapping cross section of the cavity. Thus, the wall portion surrounding the aperture still affects formation of the beet during growth. However, the head and leaves can grow through the aperture towards a light source in order to develop photosynthetic activity, although the beet is still located inside the cavity.

According to the present invention, it is furthermore preferred that the apparatus comprises a light source, in particular a light-emitting diode (LED) irradiating at least the illumination aperture. Advantageously, use of an artificial light source decouples the growing period of beets inside the cavity from the actual weather, season and day-time conditions. In particular, growth periods and crop rotations can be significantly accelerated, so that multiple harvesting periods can be realized per year.

According to the present invention, it is furthermore preferred that the base element comprises a stationary element and a movable element, wherein the movable element is movable relative to the stationary element increasing the size of the cavity during growth of the beet. Preferably, the movable element is movable between a starting position and an end position, wherein preferably the base element comprises a mechanical stop defining the end position and/or wherein the movable element is spring loaded into the starting position by spring means. Advantageously, the cavity can expand with growth of the beet or beet seedling until the movable element contacts the mechanical stop. Thus, the head and leaves of the beet can always extend through the aperture in order to be illuminated by the light source. Preferably, the aperture is located in the movable element which is simultaneously the upper part. The movable element is particularly slidable relatively to the stationary element. The stationary element is preferably the lower part comprising the bottom and the optionally the openable flap. After the movable part reaches the stop, the form of the beet is affected by the wall of the movable part and the stationary part.

According to the present invention, it is furthermore preferred that the apparatus comprises at least one sensor detecting mechanical contact and/or pressure between the beet and at least one surface wall of the cavity. It is hereby advantageously possible to detect the degree of growth of the beet as the force on the walls of the cavity by the growing beet increases with growth.

Another object of the present invention is a plant for artificial cultivation of beet plants, in particular sugar beets, comprises multiple apparatuses according to the present invention. Preferably, the plant comprises an apparatus arrangement system in which apparatuses are stacked one above the other and/or arranged side by side. It is hereby advantageously possible to optimize the yield per unit/area as the apparatuses are stacked one above the other and/or on top of each other as close as possible. Simultaneously, the required energy for climate control inside the plant per beet decreases. Preferably, the plant comprises a beet removal system for transporting beets from multiple apparatuses out of the apparatus arrangement system. Advantageously, the beet removal system comprises a conveyor system being able to transport several beets from different apparatuses simultaneously out of the apparatus arrangement system and in particular to a further processing unit, like a slicer or cutter. It is conceivable that the beet removal system comprises a belt conveyor being located beneath several apparatuses, so that beets ejected automatically through the flaps are landing on the belt conveyor and being transported towards the further processing unit.

Another subject of the present invention is a method for artificial cultivation of beet plants, in particular sugar beets, by using an apparatus, in particular the apparatus according to the present invention, comprising the steps of:
Providing a beet or beet seedling in a cavity of a formative structure of the apparatus;
Supplying the beet or beet seedling with water and/or a nutrient solution inside the cavity during growth;
Removal of the at least partially formed grown beet out of the cavity.

The described method provides the same advantages as mentioned in connection with the apparatus according to the present invention. Any explanations and preferred embodiments described for the apparatus apply also for the method and vice versa.

According to the present invention, it is furthermore preferred that the size of the cavity is increased with beet growth.

According to the present invention, it is furthermore preferred that the water and/or nutrient solution is distributed within a base element of the formative structure by an intermediate liquid-bearing layer and provided to the beet through a liquid-permeable inner layer of the base element.

According to the present invention, it is furthermore preferred that the beet is removed from the cavity through an ejecting device, in particular by opening a flap of the base element.

According to the present invention, it is preferred that the cavity is partly or completely filled with a liquid, gaseous and/or vaporous water and/or nutrition solution for soilless cultivation of the beet plant, in particular aeroponic or hydroponic cultivation. Advantageously, the fully-grown beet must not be washed prior to further processing.

Another subject of the present invention is a beet plant, in particular sugar beet, preferably cultivated by the method according to the invention, wherein the beet plant comprises at least one planar surface area. The at least planar surface is achieved by letting the beet grow up inside the cavity of the formative structure. Preferably, the beet comprises at least two, four or six planar surfaces. Preferably, at least two surfaces are orthogonal to each other and/or wherein at least two further surfaces are parallel to each other. It is conceivable that the outer shaping of the beet plant is substantially cylindrical, conical, cuboid, cubic, cubic, cuboid with rounded edges or cubic with rounded edges.

According to the present invention, it is furthermore preferred that the beet plant has a height between 50 and 300 Millimeters, preferably between 80 and 200 Millimeters and particularly preferably between 100 and 150 Millimeters, wherein particularly the beet plant has this height over a width of at least 100 Millimeters, preferably of at least 250 Millimeters and particularly preferably of at least 300 Millimeters. In this way, the cultivated beet plant comprises an advantageous shape for being transported and sliced into strips, preferably the strips are as equal as possible due to their lengths and do not contain short strips.

These and other characteristics, features and advantages of the present invention will become apparent from the following detailed description, taken in conjunction with the accompanying drawings, which illustrate, by way of example, the principles of the invention. The description is given for the sake of example only, without limiting the scope of the invention.

The reference figures quoted below refer to the attached drawings.

### BRIEF DESCRIPTION OF THE DRAWINGS

FIG. 1 illustrates schematically an apparatus according to an exemplary first embodiment of the present invention.

FIG. 2 illustrates schematically an apparatus according to an exemplary second embodiment of the present invention.

FIGS. 3a to 3b illustrate schematically an apparatus, a method and a beet plant according to an exemplary third embodiment of the present invention.

FIGS. 4a to 4b illustrate schematically an apparatus and a method according to an exemplary fourth embodiment of the present invention.

FIG. 5 illustrates schematically an apparatus according to an exemplary fifth embodiment of the present invention.

FIG. 6 illustrates schematically a plant according to an exemplary sixth embodiment of the present invention.

FIG. 7 illustrates schematically a plant and a method according to an exemplary seventh embodiment of the present invention.

### DETAILED DESCRIPTION

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn on scale for illustrative purposes.

Where an indefinite or definite article is used when referring to a singular noun, e.g. “a”, “an”, “the”, this includes a plural of that noun unless something else is specifically stated.

Furthermore, the terms first, second, third and the like in the description and in the claims are used for distinguishing between similar elements and not necessarily for describing a sequential or chronological order. It is to be understood that the terms so used are interchangeable under appropriate circumstances and that the embodiments of the invention described wherein are capable of operation in other sequences than described of illustrated herein.

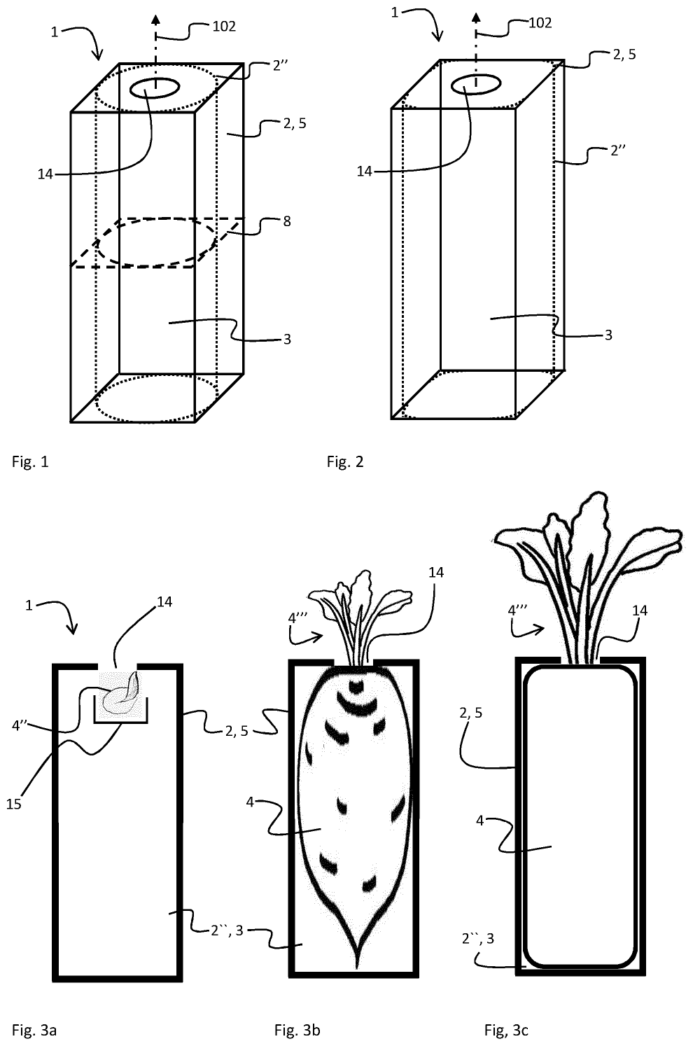

In FIG. 1, an apparatus 1 for artificial cultivation of beet plants according to an exemplary first embodiment of the present invention is schematically shown. Even though the present invention is not limited to cultivation of sugar beets, the present example and also the following examples refers exemplary to artificial cultivation of sugar beets 4.

Said apparatus 1 comprises a rigid formative structure 2 having a cavity 3. The cavity 3 is provided to receive a sugar beet seedling 4′ and to contain one single growing sugar beet 4 arising from the seedling 4′ till harvesting of this corresponding grown-up sugar beet 4.

Said cavity 3 is designed in such a manner that the outer shape 4″ of the sugar beet 4 is affected by the walls of the cavity 3 during growth of the sugar beet 4.

The formative structure 2 comprises a base element 5 with an inner contour 2′ defining the cavity 3, wherein the inner surface 2′ of the base element 5 is defined by the walls of the cavity 3. The inner contour 2′ comprises a cylindrical shape extending along a vertical longitudinal axis 102, wherein the inner contour 2′ comprises a circular cross section perpendicular to the vertical longitudinal axis 102. The base element 4 comprises a closed bottom limiting the cavity 3 on its lower end. Furthermore, the base element 4 comprises an upper limitation provided with a central aperture 14 through which head and leaves 4″′ of the growing beet 4 can extent towards a light source 11.

During grow up of the sugar beet 4, the volume of the sugar beet 4 in the cavity 3 continuously expands until it contacts the wall of the cavity 3. The base element 5 is designed that stiff and rigid so that the walls can mechanically withstand the corresponding growth momentum of the growing beet 4. Consequently, beet 4 has to adapt itself in shape to the form of the inner contour 2′ during further growth. The size of the inner contour 2′ is designed in such a manner that the size of the cavity 3, in particular the diameter perpendicular to the vertical longitudinal axis 102 and/or the height along the vertical longitudinal axis 102, is smaller than a typical grown-up sugar beet 4 being cultivated outside the cavity 3 till harvesting.

Ultimately, the harvested sugar beet 4 grown up in the cavity 3 of the apparatus 1 has an outer shape 4″ being at least similar to the cylindrical shape of the inner contour 2′.

As a result, further processing of the harvested sugar beets 4 can be performed more efficiently and with less energy consumption. In particular, slicing beets into strips and diffusing those strips in water by countercurrent exchange in order to produce sugar is optimized as the cylindrical outer shape of the harvested sugar beets 4 leads to longer strips during slicing and significantly decreases the number of so-called short strips. Suchlike short strips adversely affect the countercurrent exchange inside the extractor (also referred to as diffuser) as they tend to clog the sieves in the extractor.

The cavity 3 is preferably filled with a liquid, gaseous and/or vaporous nutrition solution for soilless aeroponic or hydroponic cultivation of the sugar beet 4. Advantageously, the fully-grown beet must not be washed prior to further processing.

Preferably, the base element 5 is made of a liquid-permeable material, e. g. a perforated fiberglass-reinforced plastic in order to supply water and a nutrient solution to the seedling 4′ and the sugar beet 4 inside the cavity 3. Advantageously, the soilless cultivation can be achieved by supplying nutrient through the base element 5 to the sugar beet 4, so that washing and cleaning of harvested sugar beets 4 from soil, dirt and stones is not necessary before further processing as slicing and diffusing, for instance.

Alternatively, the base element 3 consists of a multilayered material as explained below in connection with FIG. 5.

Optionally, the base element 5 comprises a separation area 8 for separating the base element 5 into two different parts, an upper part and a lower part. The grown-up sugar beet 4 can easily be removed from the cavity by separating the upper part and the lower part from each other. Alternatively, the base element 5 comprises an ejection device for removal of the sugar beet 4 out of the cavity 3. Preferably, the ejection device is an openable flap at the bottom of the base element 5 in the form of a hinged door through which the grown-up sugar beet 4 can fall out of the cavity 3 by gravity after opening the door as explained later in connection with FIG. 7.

The inner contour preferably comprises a cross section with a diameter (if circular), a width or maximum extension (if cuboidal) respectively perpendicular to the vertical longitudinal axis having a diameter between 50 and 550 Millimeters, preferably between 100 and 450 Millimeters and particularly preferably between 150 and 400 Millimeters, most preferably between 250 and 350 Millimeters. The cavity has preferably a height along the vertical longitudinal axis between 50 and 300 Millimeters, preferably between 80 and 200 Millimeters and particularly preferably between 100 and 150 Millimeters.

In FIG. 2, an apparatus 1 for artificial cultivation of beet plants according to an exemplary second embodiment of the present invention is schematically shown. The second embodiment basically corresponds to the first embodiment, illustrated in FIG. 1. The only difference is that the second embodiment comprises a base element 5 with an inner contour 2′ which is no longer shaped cylindric but cuboidal with rounded edges. Consequently, the cross-section perpendicular to the vertical longitudinal axis 102 is not circular but formed as a foursquare with rounded edges.

Advantageously, the corresponding grown sugar beet 4 has a cuboidal outer shape 4″ which leads to further optimization of the subsequent processing steps. In particular, transportation of the resulting cuboidal-shaped sugar beet 4 is simplified as the sugar beet 4 cannot roll away due to its flat shaped shell surfaces, even if the edges are still rounded.

An apparatus 1 and a method for artificial cultivation of sugar beets 4 according to an exemplary third embodiment of the present invention is illustrated in FIGS. 3a to 3b. The apparatus 1 according to the third embodiment is preferably equal to the apparatus 1 according to the first embodiment described in connection with FIG. 1 or to the apparatus 1 according to the second embodiment described in connection with FIG. 2.

In FIG. 3a, a sugar beet seedling 4′ is set into the cavity 3 of the base element 5. It is conceivable that the seedling 4′ is located onto the bottom of the cavity 3 or onto a non-woven material or mesh arranged inside the cavity 3. Alternatively, the seedling 4′ is set onto a bio-degradable support structure, e. g. made from cellulose fibers or the like, acting as a beet seedling holder 15. The beet seedling holder 15 holds the beet seedling 4′ close to the top of the cavity 3, so that the beet 4 can grow top-down inside the cavity 3.

Afterwards, the seedling 4′ and later on the beet 4 arising from the seedling 4′ are supplied with water and a nutrient solution in order to generate growth. Simultaneously, the base element 5 is illuminated by a light source (exemplarily shown in FIGS. 5 and 7). The light of the light source, preferably a light-emitting diode (LED), is directed onto the aperture 14.

In FIG. 3b, the growing sugar beet 4 is schematically illustrated. The sugar beet 4 becomes bigger as it grows and its outer surface touches the walls of the cavity 3, so that expansion of the sugar beet 4 is limited. In this way, the outer shape 4″ of the sugar beet 4 is affected

The head and the leaves 4″′ of the sugar beet 4 extend through the aperture 14 towards the light source 11 (not shown).

A full-grown sugar beet 4′ being ready for harvesting is shown in FIG. 3c. The illustrated sugar beet 4′ is a sugar beet according to the present invention. One can see that the outer shape 4″ of the sugar beet 4′ fills out almost the entire cavity, so that the outer shape 4″ is defined by the inner contour 2″. In the present case, the sugar beet 4′ is shaped almost cuboid and therefore comprises four or even six planar surface, which are partly orthogonal and parallel to each other.

Preferably, the height of the beet plant is between 50 and 300 Millimeters, preferably between 80 and 200 Millimeters and particularly preferably between 100 and 150 Millimeters, wherein particularly the beet plant has this height over a width of at least 100 Millimeters, preferably of at least 250 Millimeters and particularly preferably of at least 300 Millimeters.

In order to remove the full-grown sugar beet 4′ from the cavity 3 for further processing, the base element 5 is separated into two parts or the ejection device, as described above, is used.

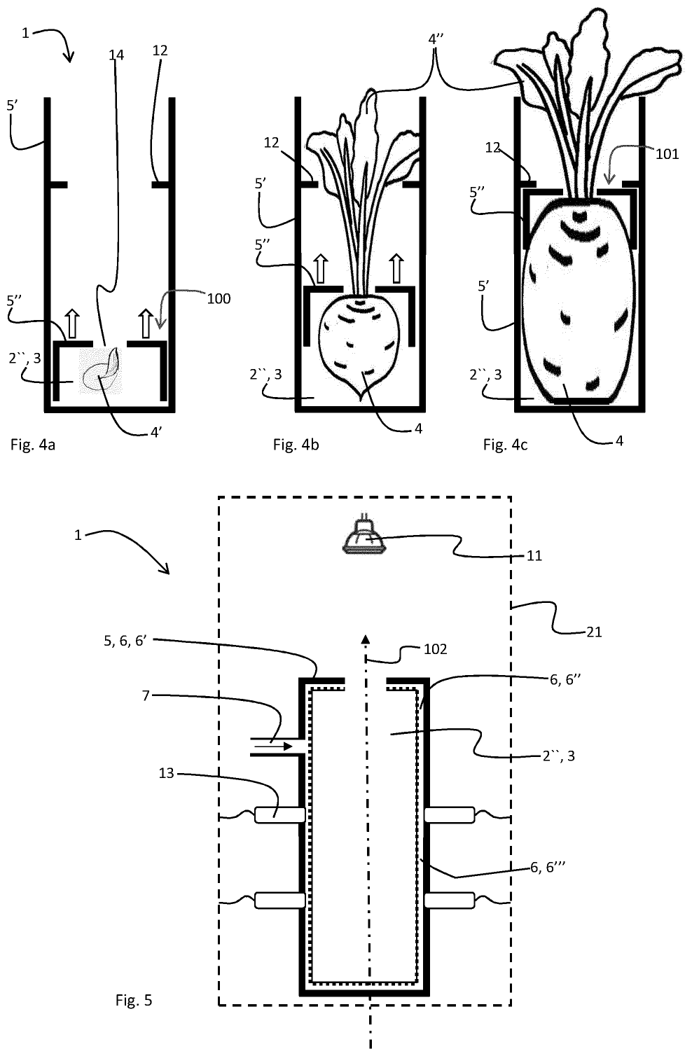

In FIGS. 4a, 4b and 4c an alternative fourth embodiment of an apparatus 1 and a method according to the present invention is schematically illustrated. The overall function is the same as described with FIGS. 3a to 3c. The only difference is that the base element 5 comprises a stationary part 5′ and a movable part 5″ which is guided and supported slidable inside the stationary part 5′. The movable part 5″ can move between a starting position 100 shown in FIG. 4a and an end position 101 shown in FIG. 4c.

In the starting position, shown in FIG. 4a, the movable part 5″ is in its lowest position near the bottom of the stationary part 5″. Thus, the cavity 3 is so small that the walls of the cavity 3 are close to the seedling 4′ and that light shining through the aperture 14 falls onto the seedling 4′. If the seedling 4′ builds up its first leaves 4″′, they are immediately irradiated with light, so that photosynthesis can start from the very first state. When the root becomes bigger and bigger as it grows, the movable part 5′ is pushed upwardly (as indicated by the upwardly pointing arrows) by the upper surface of the sugar beet 4 as shown in FIG. 4b. At the same time, the head and leaves of the growing sugar beet 4 still extend through the aperture 14 and are therefore perfectly irradiated by the light source 11 (not shown in FIGS. 4a to 4c).

The movable part 5′ is pushed upwards by the sugar beet 4 until it hits mechanical stopping means 12 limiting the upward movement and defining the end position 101, as shown in FIG. 4c. In the end position 101, the maximum height of the cavity 3 is reached and the sugar beet 4 has to adapt its outer shape 4″ to the inner contour 2″ for further expansion during growth.

In FIG. 5, an apparatus 1 according to an exemplary fifth embodiment of the present invention is shown. The fifth embodiment is similar to the second embodiment, explained by means of FIG. 2.

The apparatus 1 according to the fifth embodiment comprises a base element 5 made of a multilayered material 6. The multilayer material 6 comprises at least an outer layer 6′, an inner layer 6″′ and an intermediate layer 6″ being located between the outer layer 6′ and the inner layer 6″′.

Furthermore, the base element 5 comprises a fluid inlet 7 fluidly connected to the intermediate layer for conducting water and nutrient solution to the cavity 3.

The outer layer 6′ is impermeably to liquid, so that the supplied water and nutrient solution

cannot leave the base element 5. Preferably, the outer layer 6′ provides also rigidness and stiffness to the base element 6. It is conceivable that the outer layer 6′ is a thick foil, e. g. a deep-drawn Aluminum or plastic foil. The outer layer 6′ can also be manufactured by injection molding. Alternatively, the outer layer 6′ comprises a fiberglass-reinforced plastic.

The inner layer 6″′ is at least partly water-permeable in order to direct the water and nutrient solution towards the cavity 3 and thus also to the seedling 4′ or sugar beet 4.

For this purpose, the inner layer 6″′ preferably comprises multiple orifices or perforations evenly distributed over the surface of the inner layer 6″′. The inner layer 6″′ is preferably a thin synthetic, steel or Aluminum foil being punctured.

The intermediate layer 6″ functions as a fluid-bearing layer for distributing the water and nutrient solutions supplied through the fluid inlet 7 evenly towards the orifices of the inner layer 6″′. For this purpose, the intermediate layer 6″ preferably comprises a porous structure or a layer made of a non-woven, in particular a fleece or felt structure, in order to allow transverse flow of fluid inside the intermediate layer 6″.

In FIG. 5, the light source 11 is schematically shown. The light source 11 is located above the aperture 14 in order to illuminate head and leaves 4″′ of the sugar beet 4. The light source 11 is particularly a light-emitting diode (LED) which has a comparatively low energy consumption.

In particular, the embodiment according to FIG. 5 is perfectly suited for cultivation of the sugar beet 4 in soil. In this case, the cavity 3 is preferably filled with soil and the nutrient solution is supplied to the soil through the porous structure.

Optionally, the base element 5, shown in FIG. 5, furthermore comprises multiple sensors 13 detecting mechanical forces acting on the walls of the cavity 3 induced by growth of the sugar beet 4 and the mechanical contact between the growing beet 4 and the corresponding wall. The forces detected by the sensors 13 can be used as a measure for the state of growth of the sugar beet 4.

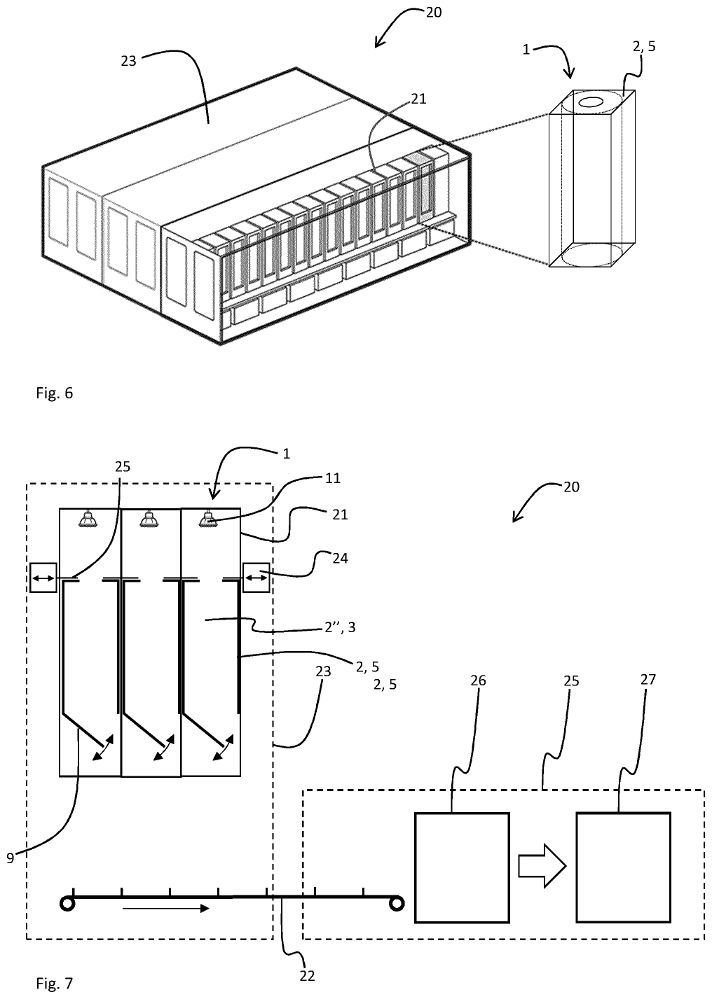

In FIG. 6, a plant 20 according to an exemplary sixth embodiment of the present invention is schematically illustrated. The plant 20 comprises multiple apparatuses 1, each designed and working according to one of the embodiments of FIGS. 1 to 5, as set out above. The apparatuses 1 are arranged adjacent and next to each other by means of an apparatus arrangement system 21. The plant 20 consists of a plurality of containers 23, wherein each container 23 comprises multiple apparatuses 1. Every container 23 provides a closed artificial environment for enhanced artificial cultivation of the sugar beets 4′ located inside the apparatuses 1. Preferably, a plurality of containers 23 or a plurality of apparatuses 1 inside one container 23 are stacked on top of each other (not shown in FIG. 6 for the sake of clarity) in order to increase quantity and density of apparatuses 1. It is conceivable that each container 3 comprises a global beet removal system 22 for automatically transporting sugar beets 4 from more than one apparatus 1 out of the apparatus arrangement system 21, out of the container 20 and/or to further processing stations. The beet removal system 22 is explained in more detail below in connection with FIG. 7.

Advantageously, usage of standardized containers 20 for building up the plant 20 allows to easily build up individually sized plants 20 adapted to specific production needs.

In FIG. 7, a plant 20 and a method according to an exemplary seventh embodiment of the present invention is schematically shown. On the left side, a plant 20, as shown in FIG. 6, is illustrated. The plant 20 comprises multiple apparatuses 1, wherein each apparatus 1 comprises an ejection device 9. The ejection device 9 respectively comprises a door 9′ forming the bottom of the base element 5. The door 9′ can be opened by swiveling about a hinge in order to remove the sugar beet 4 by gravity. Once the door 9′ is opened, the full-grown sugar beet 4 falls out of the cavity 3 onto the beet removal system 22 arranged underneath multiple the apparatuses 1. The beet removal system 22 comprises a belt conveyor for transporting the harvested sugar beets 3 out of the container 21 towards a subsequent processing station 24.

Optionally, a cutting device 24 is implemented for cutting off the head and the leaves 4″′ from the grown-up sugar beet 4′ before removal. It is conceivable that the cutting device 24 comprises a movable cutting blade 25 with a plurality of cutting offices, wherein each cutting orifice corresponds with one aperture 14, so that a relative movement of the cutting blade 25 relatively to the base elements 5 cut off head and leaves 4″′ of multiple sugar beets 4.

In the present example, said subsequent processing stations 24 are located in a separate plant building. The processing stations 24 comprising a slicing station 26 for slicing harvested sugar beets 4 top-down or crosswise into strips and a diffusing station 27 to generate a sugar mass from the strips by countercurrent exchange with water. For this purpose, the diffusion station 27 comprises a sieve which is not clogged by too short strips anymore, as the strips coming from the actively shaped sugar beets 4 by means of the formative structure 2 have a more equal length and size.

### LIST OF REFERENCE SIGNS

1 Apparatus
2 Formative structure
2′ Inner contour
3 Cavity
4 Beet
4′ Beet seedling
4″ Outer shape of the beet
4′″ Head and leaves of the beet
5 Base element
5′ Stationary element
5″ Movable element
6 Multilayered material
6′ Outer layer
6″ Intermediate liquid-bearing layer
6′″ Inner layer
7 Fluid inlet
8 Separation area
9 Ejection device
10 Illumination aperture
11 Light source
12 Mechanical stop
13 Sensor
14 Aperture
15 Beet holder
20 Plant
21 Apparatus arrangement system
22 Beet removal system
23 Container
24 Cutting device
25 Cutting blade
25 Further processing stations
26 Slicing station
27 Diffusing station
100 Starting position
101 End position
102 Vertical longitudinal axis

1. Apparatus for cultivation of a beet plant, the apparatus comprising a formative structure with a cavity for containing the beet plant, wherein the formative structure is designed such that an outer shape of the beet plant is at least partially affected by walls of the cavity during growth of the beet plant

2. Apparatus according to claim 1, wherein the cavity is designed for containing only one single beet plant.

3. Apparatus according to claim 1, wherein the formative structure comprises a base element providing the cavity, wherein the base element comprises a cylindrical, conical, cuboid, or cubic inner contour, and/or the inner contour is shaped cuboid or cubic with rounded edges.

4. Apparatus according to claim 3, wherein the base element is rigid or semi rigid.

5. Apparatus according to claim 3, wherein the base element comprises one or more liquid-permeable areas or wherein the base element is made of a liquid-permeable and porous and/or perforated material.

6. Apparatus according to claim 3, wherein the base element is made of a multilayered material comprising an outer layer being impermeable to liquid, an intermediate liquid-bearing layer for distribution of water within the base element, and an inner layer being permeable to liquid to guide the distributed water to the cavity.

7. Apparatus according to claim 6, wherein the apparatus comprises a fluid inlet for water and/or a nutrient solution, wherein the fluid inlet is connected to the intermediate liquid-bearing layer.

8. Apparatus according to claim 1, wherein the base element comprises a separation area for separating the base element into at least two parts or an ejection device for removal of the beet out of the cavity, the ejection device being an openable flap.

9. Apparatus according to claim 1, wherein the base element comprises an illumination aperture through which a head and leaves of the beet plant can grow out of the cavity.

10. Apparatus according to claim 9, wherein the apparatus comprises a light source or a light-emitting diode irradiating at least the illumination aperture.

11. Apparatus according to claim 1, wherein the base element comprises a stationary element and a movable element, wherein the movable element is movable relative to the stationary element increasing the size of the cavity during growth of the beet plant.

12. Apparatus according to claim 1, wherein the movable element is movable between a starting position and an end position, wherein the base element comprises a mechanical stop defining an end position and/or wherein the movable element is spring loaded into the starting position by spring means.

13. Apparatus according to claim 1, wherein the apparatus comprises at least one sensor detecting mechanical contact and/or pressure between the beet plant and at least one surface wall of the cavity.

14. Plant for artificial cultivation of a beet plant comprising a multiple of the apparatus according to claim 1.

15. Plant according to claim 14, wherein the plant comprises an apparatus arrangement system in which the multiple apparatuses are stacked one above the other and/or arranged side by side.

16. Plant according to claim 14, wherein the plant comprises a beet removal system for transporting the beets from the multiple apparatuses out of the apparatus arrangement system.

17. Method of using the apparatus according to claim 1, comprising the steps of:
a. providing the beet plant or a beet seedling in the cavity of the formative structure of the apparatus;
b. supplying the beet plant or the beet seedling with water and/or a nutrient solution inside the cavity during growth;
c. removing of the at least partially formed grown beet plant out of the cavity.

18. Method according to claim 17, wherein a size of the cavity is increased with beet growth.

19. Method according to claim 17, wherein the water and/or the nutrient solution is distributed within a base element of the formative structure by an inter-mediate liquid-bearing layer and is provided to the beet plant through a liquid-permeable inner layer of the base element.

20. Method according to claim 17, wherein the beet plant is removed from the cavity through an ejecting device, by opening a flap of the base element.

21. The beet plant cultivated by the method according to claim 17, wherein the beet plant comprises at least one planar surface area.

22. Beet plant according to claim 21, wherein the beet plant comprises at least two, four or six planar surfaces.

23. Beet plant according to claim 22, wherein at least two surfaces are orthogonal to each other and/or wherein at least two further surfaces are parallel to each other.

24. Beet plant according to claim 21, wherein the outer shaping of the beet plant is substantially cylindrical, conical, cuboid, cubic, cubic, cuboid with rounded edges or cubic with rounded edges.

25. Beet plant according to claim 21, wherein a height of the beet plant is between 50 and 300 Millimeters, or between 80 and 200 Millimeters, or between 100 and 150 Millimeters, wherein the beet plant has the height over a width of at least 100 Millimeters, or at least 250 Millimeters, or at least 300 Millimeters.
